(19) United States
(12) Patent Application Publication
(10) Pub. No.: US 2012/0145701 A1
(43) Pub. Date: Jun. 14, 2012

(54) ELECTRICAL RESISTANCE HEATER AND HEATER ASSEMBLIES

(76) Inventors: Ronald L. Colvin, Gilbert, AZ (US); Dennis Goodwin, SR., Happy Jack, AZ (US); Jeff Mittendorf, Chandler, AZ (US); Charles J. Moretti, Scottsdale, AZ (US); John W. Rose, Cave Creek, AZ (US); Earl Blake Samuels, Scottsdale, AZ (US)

(21) Appl. No.: 13/194,945

(22) Filed: Jul. 30, 2011

Related U.S. Application Data
(60) Provisional application No. 61/369,077, filed on Jul. 30, 2010.
(60) Provisional application No. 61/369,072, filed on Jul. 30, 2010.

(51) Int. Cl. H05B 3/12

(52) U.S. Cl. 219/553

(57) ABSTRACT

Electrical resistance heater and heater assemblies are described. According to one embodiment, the heater comprises a sinusoidal heating element that provides substantially constant heating. According to another embodiment, the heater comprises a heating element and one or more press-fit coupled electrical adapters. Methods and systems are also disclosed.

### CROSS-REFERENCE TO RELATED APPLICATIONS

The present application claims benefit of U.S. Patent Application Ser. No. 61/369,077, Docket No. LAS-002, titled “ELECTRICAL RESISTANCE HEATER AND HEATER ASSEMBLIES,” to Ronald L. Colvin et al., filed Jul. 30, 2010. The present application is related to: U.S. patent application Ser. No. 13/193,498, filed Jul. 28, 2011; U.S. Patent Application Ser. No. 61/369,047, Docket No. LAS-001, titled “SUBSTRATE PROCESSING APPARATUSES AND SYSTEMS,” to Ronald L. Colvin et al., filed Jul. 29, 2010; U.S. Patent Application Ser. No. 61/369,072, Docket No. LAS-003, titled “SYSTEMS, APPARATUSES, AND METHODS FOR CHEMICALLY PROCESSING SUBSTRATES USING THE COANDA EFFECT,” to Ronald L. Colvin et al., filed Jul. 30, 2010; U.S. Pat. No. 6,331,212, filed 17 Apr. 2000; and U.S. Pat. No. 6,774,060, filed 7 Jul. 2001. The contents of all of these applications and patents are incorporated herein in their entirety by this reference.

### BACKGROUND

This invention relates to electrical resistance heaters, heater assemblies, and methods of their use for applications such as processing substrates; more particularly, thermally processing substrates for electronic devices and optical-electronic devices.

Thermal processing of substrates is used in numerous applications such as modern microelectronic device manufacturing. These processes include processes such as chemical vapor deposition (CVD) and epitaxial semiconductor deposition such as silicon epitaxy, silicon germanium epitaxy, and compound semiconductor epitaxy. These processes are typically performed using one or more gases for causing reactions on the surface of substrates such as semiconductor wafers, flat panel display substrates, solar cell substrates, and other substrates.

### SUMMARY

This invention seeks to provide electrical resistance heaters, heater assemblies, and methods and that can overcome one or more deficiencies in thermal processes and process equipment. One aspect of the inventions is a heater or heater assembly. Another aspect of the invention is a method of performing a thermal process on a substrate.

It is to be understood that the invention is not limited in its application to the details of construction and to the arrangements of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

### BRIEF DESCRIPTION OF THE DRAWINGS

FIG. 1 is a back view of an embodiment of the present invention.

FIG. 1-1 is a perspective back view of an embodiment of the present invention.

FIG. 1-2 is a perspective view of an electrical adapter according to an embodiment of the present invention.

FIG. 1-3 is a perspective cross-section view of an electrical adapter according to an embodiment of the present invention.

FIG. 2 is a back view of an embodiment of the present invention.

FIG. 2-1 is a perspective back view of an embodiment of the present invention.

FIG. 3 is a front view of an embodiment of the present invention.

FIG. 3-1 is a back view of an embodiment of the present invention.

FIG. 4 is a process diagram of an embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DESCRIPTION

For the following defined terms, these definitions shall be applied, unless a different definition is given in the claims or elsewhere in this specification. All numeric values are herein defined as being modified by the term “about,” whether or not explicitly indicated. The term “about” generally refers to a range of numbers that a person of ordinary skill in the art would consider equivalent to the stated value to produce substantially the same properties, function, result, etc. A numerical range indicated by a low value and a high value is defined to include all numbers subsumed within the numerical range and all subranges subsumed within the numerical range. As an example, the range 10 to 15 includes, but is not limited to, 10, 10.1, 10.47, 11, 11.75 to 12.2, 12.5, 13 to 13.8, 14, 14.025, and 15.

The operation of embodiments of the present invention will be discussed below in the context of thermally processing substrates such as semiconductor wafers or other substrates used for electronic and/or optoelectronic devices. It is to be understood, however, that embodiments in accordance with the present invention may be used to perform essentially any thermal process.

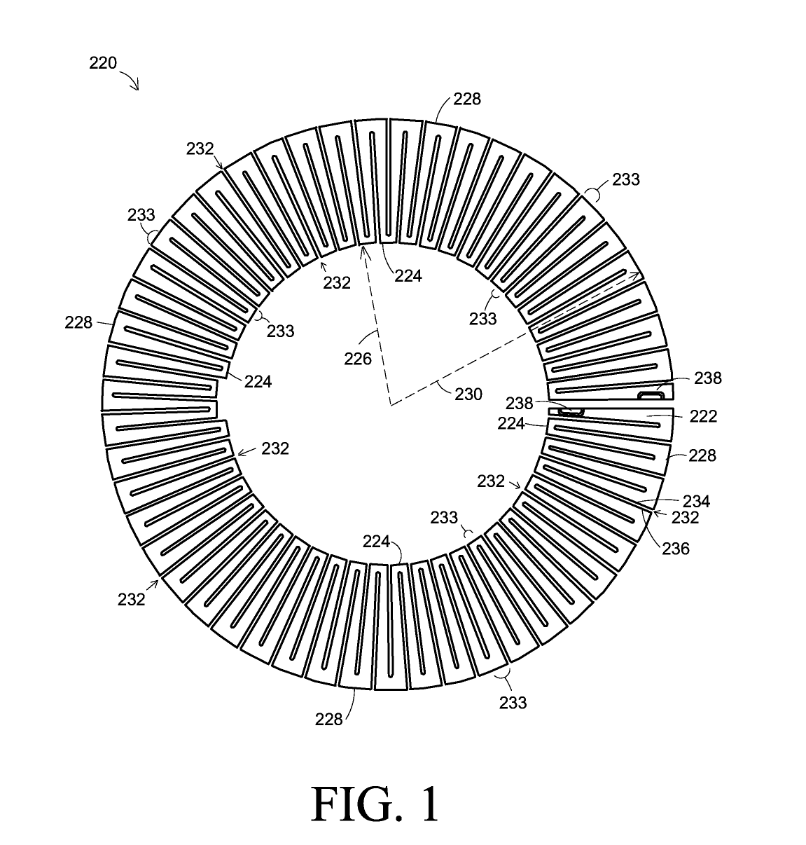

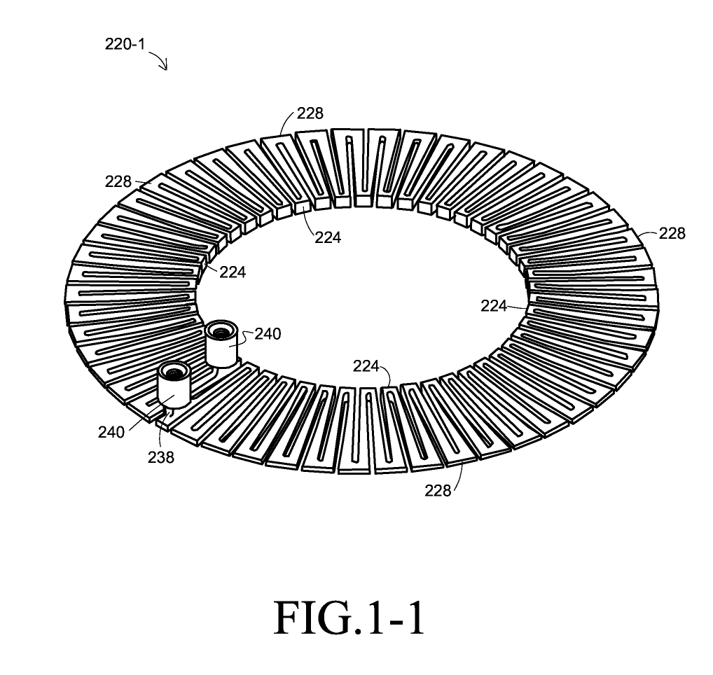

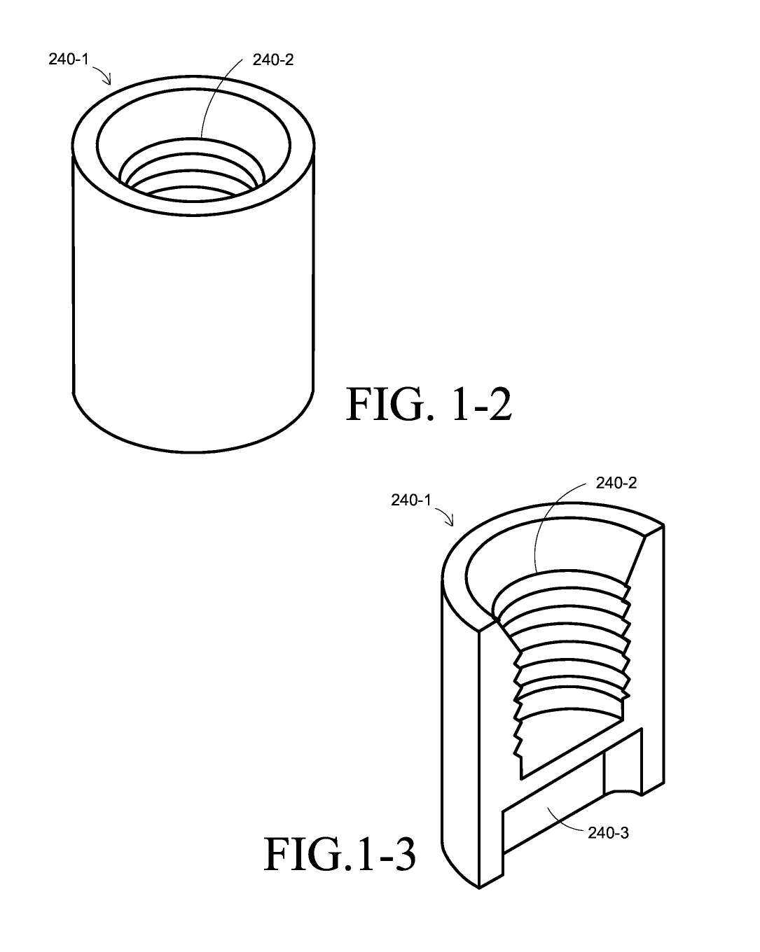

Reference is now made to FIG. 1 where there is shown a back view of an electrical resistance heater 220 according to an embodiment of the present invention. Heater 220 is formed by a sinusoidal heating element 222 having a plurality of troughs 224 disposed to delineate an inner radius 226 and a plurality of peaks 228 disposed to delineate an outer radius 230. In other words, heater 220 forms a ring or section of a ring having an inner radius 226 and an outer radius 230 so as to make heater 220 circular, either a circle or part of a circle. The cross-section width of sinusoidal heating element 222 is a first function of radial position and the cross-section thickness of sinusoidal heating element 222 is a second function of radial position so that sinusoidal heating element 222 provides a substantially constant heat flux at each radial position and forms a substantially constant spacing 232 between facing side surfaces 234 and 236 of sinusoidal heating element 222. Spacing 232 between facing side surfaces of sinusoidal heating element 222 is maintained at a selected constant and may be kept to a minimum with the limits being determined by the need to avoid arcing, thermal expansion and contraction limitations, and fabrication limitations. Heating element 222 can be represented as having a plurality of spokes 233 extending from the inside radius 226 to the outside radius 230.

The cross-section area of sinusoidal heating element 222 is given by the multiplying the cross-section width of sinusoidal heating element 222 generally at each radial position by the cross-section thickness of sinusoidal heating element 222 generally at each radial position. The cross-section area varies with radial position based on the size of the surface to be heated and the wattage requirement. Additional factors that determine the cross-section area of the sinusoidal heating element are the number of oscillations in the sinusoidal heating element, resistivity of the sinusoidal heating element, spacing between facing sides of the sinusoidal heating element, and the length of the sinusoidal heating element.

As indicated above, the cross-section thickness and the cross-section width of the heating element at each radial position are functions of the radial position on the sinusoidal heating element. The thickness can be represented in general by a function of the form f₁(1/r) where r is radial position on the sinusoidal heating element and f₁ is the function. The term 1/r is used to indicate that the relation is an inverse relation. The width can be represented in general by a function of the form f₂(r) where r is radial position on the sinusoidal heating element and f₂ is the function. Consequently, the cross-section area of the sinusoidal heating element is a function of the form (f₁(1/r)(f₂(r)).

For some embodiments of the present invention, the cross-section thickness of the sinusoidal heating element is derived from the equation:

t=2πrᵢ²Gtᵢ/(2πr²G−Sr) (1)

where t is cross-section thickness of the heating element, r is radial position on the heating element, π is the mathematical constant pi, rᵢ is an inside radius of the heating element, tᵢ is an initial trial thickness, G is a geometry factor equaling the angular width of the heating element spoke divided by the angular size of the heater, and S is the spacing between facing side surfaces of the heating element. More specifically, t and r are variables and π, rᵢ, tᵢ, G, and S are numerical parameters. With the knowledge of the numerical parameters for a heater, the thickness can be calculated as a function of radial position.

As will be recognized by persons of ordinary skill in the art, Equation 1 and the numerical parameters are the result of only one approach to obtaining a numerical representation of the dimensions of heaters according to one or more embodiments of the present invention. Other approaches will be recognized by persons of ordinary skill in the art in view of the disclosure in this specification. The derivation of Equation (1) was accomplished using π the mathematical constant, rᵢ as a designer choice, an outside radius of the heater as a designer choice, G as a designer choice, and S as a designer choice. The initial trial thickness of the heater element at the inside radius, tᵢ, is also a designer choice, but optionally tᵢ may have to be refined by iteration so that the resistance of the heater element is more suitably matched for use with the full voltage and current capacity of the power source to be used with the heater. The capacity of the power source is also a designer choice. One possible iteration procedure is presented below in an example heater design.

It is also possible to derive the numerical parameters or equivalent constants for an equation similar to Equation (1) if heater thickness data as a function of radial position is known for a heater. A further simplified equation for such situations could be of the form:

t=A/(Br²−Sr) (1.1)

where t, r, and S are the same as presented above and A and B are numerical values resulting from combining one or more of the numerical parameters presented above.

For some embodiments of the present invention, the cross-section width of the sinusoidal heating element is derived from the equation:

w=2πGr−S (2)

where w is the cross-section width of the heating element, r is the radial position on the heating element, π is the mathematical constant pi, G is a geometry factor equaling the angular width of the heating element spoke divided by the angular size of the heater, and S is a spacing between facing side surfaces of the heating element. The width of the heating element as a function of radial position can be calculated for more one or more embodiment of the present invention with designer specified values for angular width of the heating element spoke, the angular size of the heater, and the spacing.

A variety of materials may be used for sinusoidal heating element 222. According to one embodiment of the present invention, sinusoidal heating element 222 comprises a refractory electrical conductor. The sinusoidal heating element 222 may comprise graphite such as molded graphite. Further modifications can be made such as coating the graphite with a material such as silicon carbide to produce sinusoidal heating element 222 having, as an example, a graphite conductor coated with silicon carbide. Examples of other materials that can be used for sinusoidal heating element 222 include, but are not limited to, nickel-chromium alloy, molybdenum, tantalum, tungsten, and other materials used for electrical resistance heating.

According to one embodiment of the present invention, spacing 232 between facing side surfaces of sinusoidal heating element 222 is at vacuum or filled with gas during operation of sinusoidal heating element 222.

FIG. 1 shows electrical resistance heater 220 comprising two optional electrical contacts 238 positioned approximately at each end of sinusoidal heating element 222. It is to be understood that other means of making contact can be used for electrical heater 220. Electrical contact 238 shown for the embodiment in FIG. 1 may be a tab machined as part of sinusoidal heating element 222. As an option, electrical contact 238 is oriented substantially perpendicular to the surface of electrical resistance heater 220. Other orientations for electrical contact 238 can be used as will be clear to persons of ordinary skill in the art in view of the present disclosure. Electrical contacts 238 can be used to apply a DC or AC current through sinusoidal heating element 222.

Reference is now made to FIG. 1-1 where there is shown a perspective view of an electrical resistance heater 220-1. Electrical resistance heater 220-1 is essentially the same as described for electrical resistance heater 220 described for FIG. 1 with the exception that electrical resistance heater 220-1 includes an optional electrical adapter 240 coupled with electrical contact 238 for each end of serpentine electrical conductor 222.

According to one embodiment of the present invention, electrical adapter 240 is formed so as to make a press-fit, also known in the art has an interference fit, coupling to electrical contact 238. For some embodiments of the present invention, serpentine heating element 222 may be made of graphite; as an option for those embodiments, electrical adapter 240 may be made of graphite. Optionally, electrical adapter 240 may be made of materials other than graphite that are also suitable for electrical connections.

The present inventors have found that a synergistic benefit may be occurring for embodiments of the present invention that use graphite for sinusoidal heating element 222 and graphite for electrical adapter 240 in a press-fit coupling configuration and a silicon carbide coating process. More specifically, applying a thermal coating of silicon carbide to sinusoidal heating element 222 and press-fit coupled electrical adapter 240 produces a mechanically strong connection between sinusoidal heating element 222 and electrical adapter 240 with a low contact resistance. Consequently, a strong mechanical connection is formed that is electrically conductive and it may be accomplished without complicated machining steps beyond a press-fit coupling.

The deposition conditions used for forming the silicon carbide coatings are the same as those typically used for coating graphite. Generally, a silicon source and a carbon source are caused to react at elevated temperatures such as about 1200° C. to produce a deposited coating of silicon carbide.

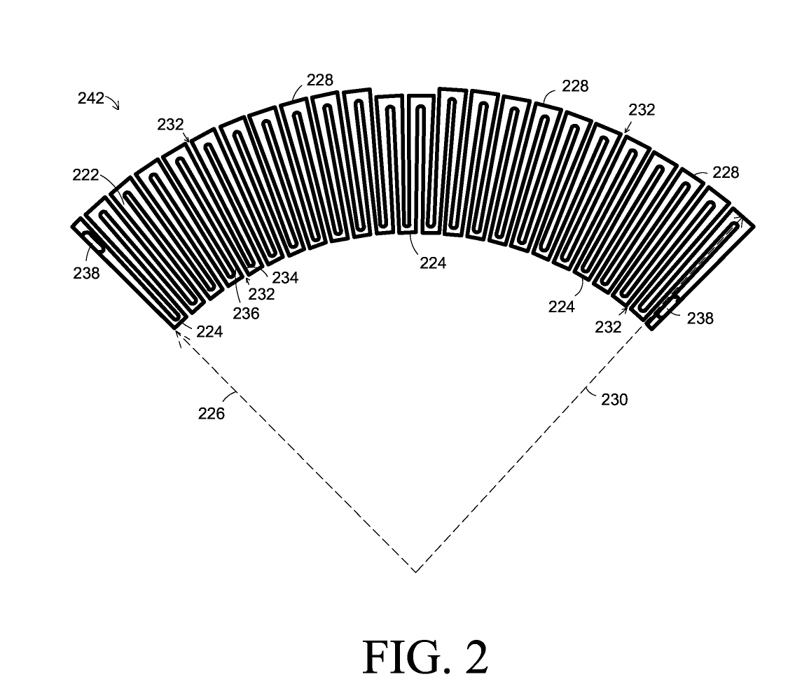

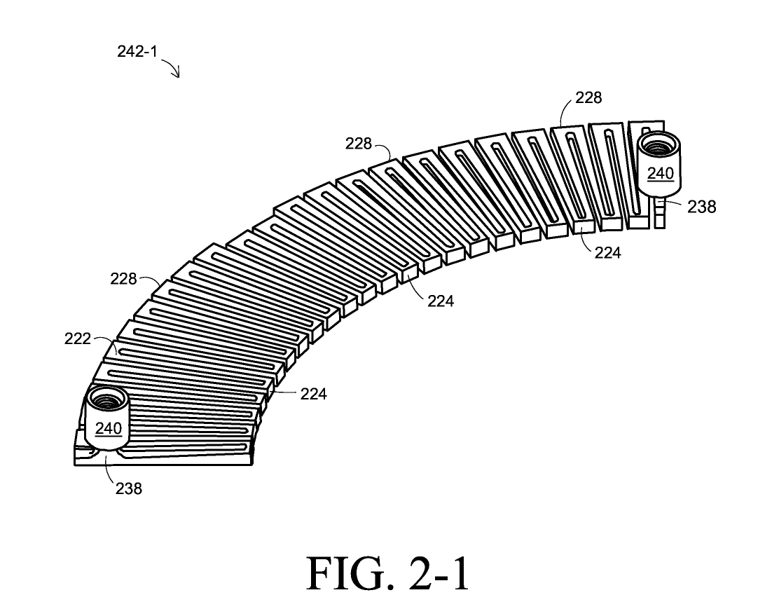

Reference is now made to FIG. 1-2 where there is shown a perspective view and FIG. 1-3 where there is shown a cross-section perspective view of an electrical adapter 240-1 suitable for one or more embodiments of the present invention. Electrical adapter 240-1 is a substantially rigid body made of a suitable electrical conductor such as graphite or other material suitable for electrical contact for an electrical resistance heater. Electrical adapter 240-1 has a threaded bore 240-2 that has been threaded for making a threaded connection. Electrical adapter 240-1 has a press-fit bore 240-3 that has been configured to make a press-fit coupling with electrical contacts of electrical resistance heaters such as, but not limited to, electrical resistance heater 220.

Reference is now made to FIG. 2 where there is shown a back view of an electrical resistance heater 242 according to an embodiment of the present invention. Heater 242 is formed by a sinusoidal heating element 222 having a plurality of troughs 224 disposed to delineate an inner radius 226 and a plurality of peaks 228 disposed to delineate an outer radius 230. In other words, heater 242 forms a section of a ring having an inner radius 226 and an outer radius 230 so as to make heater 242 a part of a circle. The cross-section width of sinusoidal heating element 222 is a first function of radial position and the cross-section thickness of sinusoidal heating element 222 is a second function of radial position so that sinusoidal heating element 222 provides a substantially constant heat flux at each radial position and forms a substantially constant spacing 232 between facing side surfaces 234 and 236 of sinusoidal heating element 222. Spacing 232 between facing side surfaces of sinusoidal heating element 222 is maintained at a selected constant and may be kept to a minimum with the limits being determined by the need to avoid arcing, thermal expansion and contraction limitations, and fabrication limitations.

The cross-section area of sinusoidal heating element 222 is given by the multiplying the cross-section width of sinusoidal heating element 222 generally at each radial position by the cross-section thickness of sinusoidal heating element 222 generally at each radial position. The cross-section area is held at a selected constant based on the size of the surface to be heated and the wattage requirement. Additional factors that determine the cross-section area of the sinusoidal heating element are the number of oscillations in the sinusoidal heating element, resistivity of the heating element, spacing between facing sides of the sinusoidal heating element, and the length of the sinusoidal heating element.

As indicated above, the cross-section thickness and the cross-section width of the heating element at each radial position are functions of the radial position on the sinusoidal heating element. The thickness can be represented in general by a function of the form f₁(1/r) where r is radial position on the sinusoidal heating element and f₁ is the function. The term 1/r is used to indicate that the relation is an inverse relation. The width can be represented in general by a function of the form f₂(r) where r is radial position on the sinusoidal heating element and f₂ is the function. Consequently, the cross-section area of the sinusoidal heating element is a function of the form (f₁(1/r))(f₂(r)).

For some embodiments of the present invention, the cross-section thickness of the sinusoidal heating element is derived from the equation:

t=2πrᵢ²Gtᵢ/(2πr²G−Sr) (1)

where t is cross-section thickness of the heating element, r is radial position on the heating element, π is the mathematical constant pi, rᵢ is an inside radius of the heating element, tᵢ is an initial trial thickness, G is a geometry factor equaling the angular width of the heating element spoke divided by the angular size of the heater, and S is the spacing between facing side surfaces of the heating element. More specifically, t and r are variables and π, rᵢ, tᵢ, G, and S are numerical parameters. With the knowledge of the numerical parameters for a heater, the thickness can be calculated as a function of radial position.

As will be recognized by persons of ordinary skill in the art, Equation 1 and the numerical parameters are the result of only one approach to obtaining a numerical representation of the dimensions of heaters according to one or more embodiments of the present invention. Other approaches will be recognized by persons of ordinary skill in the art in view of the disclosure in this specification. The derivation of Equation (1) was accomplished using π the mathematical constant, rᵢ as a designer choice, an outside radius of the heater as a designer choice, G as a designer choice, and S as a designer choice. The initial trial thickness of the heater element at the inside radius, tᵢ, is also a designer choice, but optionally tᵢ may have to be refined by iteration so that the resistance of the heater element is more suitably matched for use with the full voltage and current capacity of the power source to be used with the heater. The capacity of the power source is also a designer choice. One possible iteration procedure is presented below in an example heater design.

It is also possible to derive the numerical parameters or equivalent constants for an equation similar to Equation (1) if heater thickness data as a function of radial position is known for a heater. A further simplified equation for such situations could be of the form:

t=A/(Br²−Sr) (1.1)

where t, r, and S are the same as presented above and A and B are numerical values resulting from combining one or more of the numerical parameters presented above.

For some embodiments of the present invention, the cross-section width of the sinusoidal heating element is derived from the equation:

w=2πGr−S (2)

where w is the cross-section width of the heating element, r is the radial position on the heating element, π is the mathematical constant pi, G is a geometry factor equaling the angular width of the heating element spoke divided by the angular size of the heater, and S is a spacing between facing side surfaces of the heating element. The width of the heating element as a function of radial position can be calculated for more one or more embodiment of the present invention with designer specified values for angular width of the heating element spoke, the angular size of the heater, and the spacing.

A variety of materials may be used for sinusoidal heating element 222. According to one embodiment of the present invention, sinusoidal heating element 222 comprises a refractory electrical conductor. The sinusoidal heating element 222 may comprise graphite such as molded graphite. Further modifications can be made such as coating graphite with a material such as silicon carbide to produce sinusoidal heating element 222 having, as an example, a graphite conductor coated with silicon carbide. Examples of other materials that can be used for sinusoidal heating element 222 include, but are not limited to, nickel-chromium alloy, molybdenum, tantalum, tungsten, and other materials used for electrical resistance heating.

FIG. 2 shows electrical resistance heater 242 comprising two optional electrical contacts 238 positioned approximately at each end of sinusoidal heating element 222. It is to be understood that other means of making contact can be used for electrical heater 220. Electrical contact 238 shown for the embodiment in FIG. 2 may be a tab machined as part of sinusoidal heating element 222. As an option, electrical contact 238 is oriented substantially perpendicular to the surface of electrical resistance heater 220. Other orientations for electrical contact 238 can be used as will be clear to persons of ordinary skill in the art in view of the present disclosure. Electrical contacts 238 can be used to apply a DC or AC current through sinusoidal heating element 222.

FIG. 2 shows an optional configuration for peaks 238. Specifically, one or more of the peaks may be shorter than surrounding peaks as is shown for two of the peaks in FIG. 2. This optional configuration can be used to accommodate other structures such as attachment structures, sensors, holders that could be used for operating and monitoring electrical resistance heater 242. Similar modifications can be made to troughs 224.

Reference is now made to FIG. 2-1 where there is shown a perspective view of an electrical resistance heater 242-1. Electrical resistance heater 242-1 is essentially the same as described for electrical resistance heater 242 described for FIG. 2 with the exception that electrical resistance heater 242-1 includes an optional electrical adapter 240 coupled with electrical contact 238 for each end of serpentine electrical conductor 222.

According to one embodiment of the present invention, electrical adapter 240 is formed so as to make a press-fit, also known in the art has an interference fit, coupling to electrical contact 238. For some embodiments of the present invention, serpentine heating element 222 may be made of graphite; as an option for those embodiments, electrical adapter 240 may be made of graphite. Optionally, electrical adapter 240 may be made of materials other than graphite that are also suitable for electrical connections.

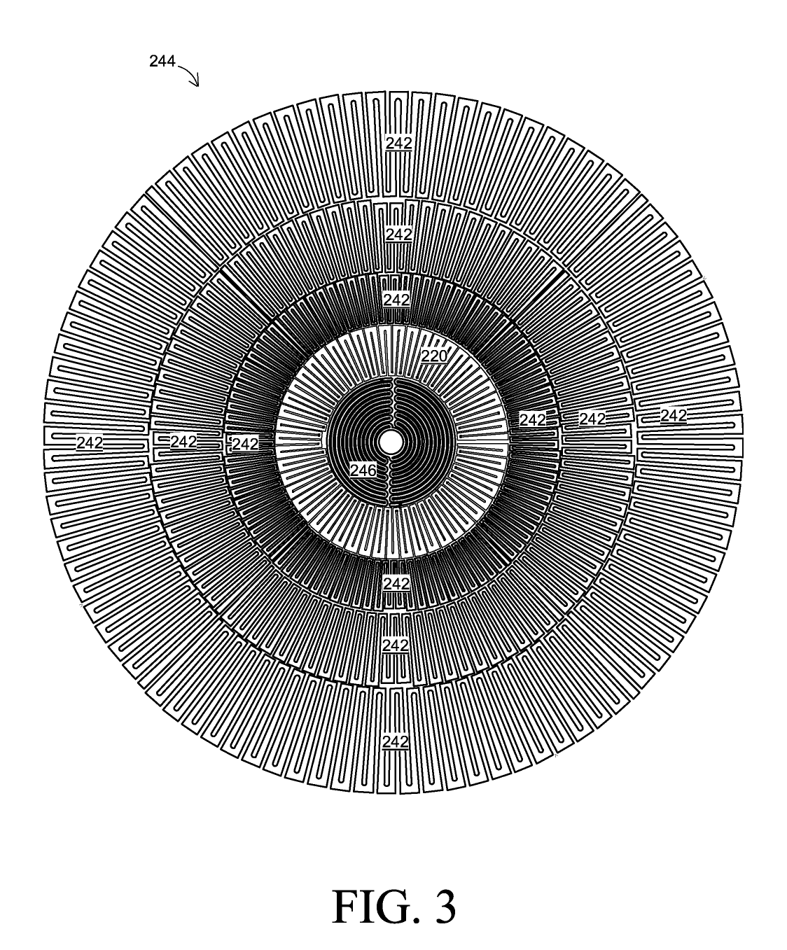

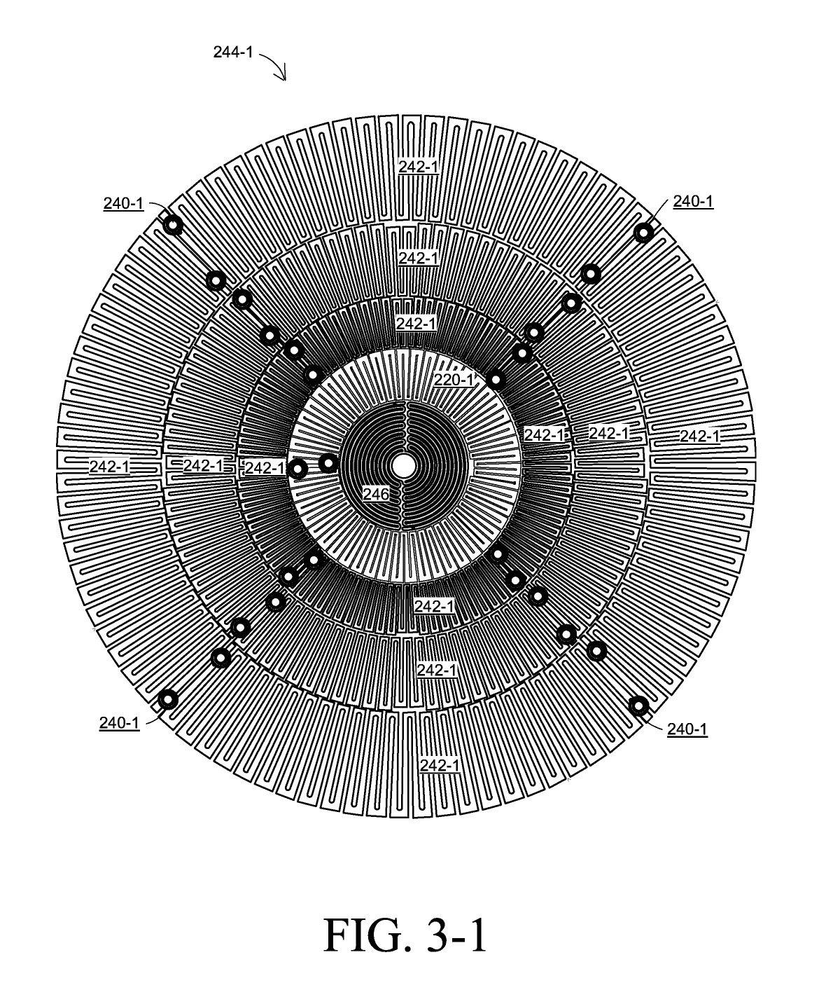

Reference is now made to FIG. 3 where there is shown a front view of a heater assembly 244 according to one embodiment of the present invention. Heater assembly 244 comprises a plurality of electrical resistance heaters shaped as rings or sections of rings. More specifically, heater assembly 244 comprises a first heater 246 located at the center. Optionally, first heater 246 may be a ring heater or a section of a ring heater. As another option, first heater 246 may be a ring heater that is essentially the same as electrical resistance heater 220 as described in FIG. 1 or a combination of electrical resistance heaters 242 as described in FIG. 2. Alternatively, first heater 246 may have a configuration other than the configuration for electrical resistance heaters 220 and electrical resistance heaters 242 described supra. The embodiment of the present invention shown in FIG. 3 has first heater 246 including a heating element having a dissimilar configuration to those of electrical resistance heaters 220 and electrical resistance heaters 242.

Heater assembly 244 further comprises an electrical resistance heater 220 surrounding first heater 246. Electrical resistance heater 220 is essentially the same as described for electrical resistance heaters 220 in FIG. 1.

Heater assembly 244 further comprises 12 electrical resistance heaters 242 shaped as quarter ring sections and disposed so as to form a substantially planar array of concentric rings for a substantially circular heated area. Electrical resistance heater 242 is essentially the same as described for electrical resistance heaters 242 in FIG. 2. It is to be understood that other embodiments of the present invention may use a number electrical resistance heaters 242 other than 12 and that the combination of ring heaters and sections of ring heaters may also differ from what is described for FIG. 3. Specifically, more than 12 electrical resistance heaters 242 may be used in embodiments of the present invention or fewer than 12 electrical resistance heaters 242 may be used in heating assemblies according to embodiments of the present invention. Similarly, more than one electrical resistance heater 220 may be used in heating assemblies according to embodiments of the present invention or no resistance heater 220 may be used in embodiments of the present invention.

Heater assemblies according to embodiments of the present invention include at least one electrical resistance heater selected from the group consisting of: electrical resistance heater 220, electrical resistance heater 220-1, electrical resistance heater 242, and electrical resistance heater 242-1.

Reference is now made to FIG. 3-1 where there is shown a back view of a heater assembly 244-1 according to one embodiment of the present invention. Heater assembly 244-1 comprises a plurality of electrical resistance heaters shaped as rings or sections of rings. More specifically, heater assembly 244-1 comprises a first heater 246-1 located at the center. First heater 246-1 comprises electrical contacts substantially as described above (electrical contacts not visible in FIG. 3-1) and electrical adapters such as electrical adapter 240-1 substantially as described above coupled to the electrical contacts. Optionally, first heater 246-1 may be a ring heater or a section of a ring heater. As another option, first heater 246-1 may be a ring heater that is essentially the same as electrical resistance heater 220-1 as described in FIG. 1-1 or a combination of electrical resistance heaters 242-1 as described in FIG. 2-1. Alternatively, first heater 246-1 may have a configuration other than the configuration for electrical resistance heaters 220-1 and electrical resistance heaters 242-1 described supra. The embodiment of the present invention shown in FIG. 3-1 has first heater 246-1 including a heating element having a dissimilar configuration to those of electrical resistance heaters 220-1 and electrical resistance heaters 242-2.

Heater assembly 244-1 further comprises an electrical resistance heater 220-1 surrounding first heater 246-1. Electrical resistance heater 220-1 is essentially the same as described for electrical resistance heaters 220-1 in FIG. 1-1. Electrical adapters 240 for electrical resistance heater 220-1 are also shown in FIG. 3-1.

Heater assembly 244-1 further comprises 12 electrical resistance heaters 242-1 shaped as quarter ring sections and disposed so as to form a substantially planar array of concentric rings for a substantially circular heated area. Electrical resistance heater 242-1 is essentially the same as described for electrical resistance heaters 242-1 in FIG. 2-1. Electrical adapters 240 for electrical resistance heater 242-1 are also shown in FIG. 3-1.

An apparatus according to another embodiment of the present invention is an electrical resistance heater that comprises a graphite heating element. The graphite heating element has one or more graphite electrical contacts. The electrical resistance heater further comprises one or more graphite electrical adapters such as electrical adapters 240 and electrical adapters 240-1 described above. The one or more electrical adapters are press-fit coupled to the one or more graphite electrical contacts. The electrical resistance heater further includes a layer of silicon carbide overcoating the heating element and electrical adapter. The silicon carbide overcoating is applied after press-fit coupling the one or more graphite electrical contacts to the one or more electrical adapters. The silicon carbide coating may be applied using a high temperature chemical vapor deposition process.

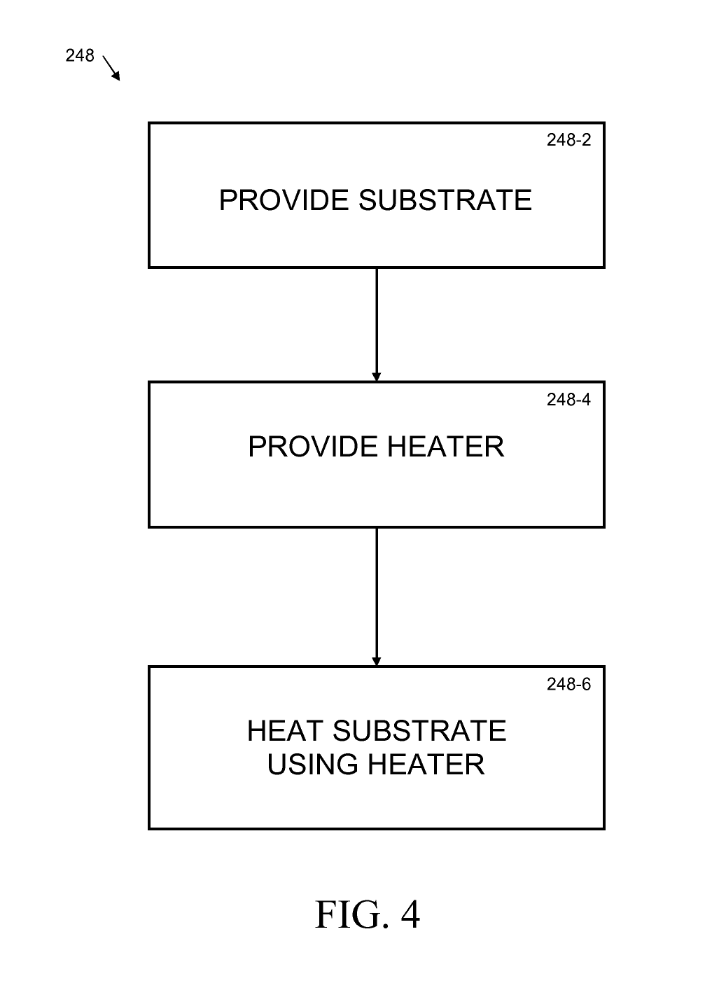

The apparatuses described supra may be used for a wide variety of processes according to embodiments of the present invention. Reference is now made to FIG. 4 where there is shown an exemplary process diagram 248 according to one embodiment of the present invention. Exemplary process diagram 248 comprises a non-exhaustive series of steps to which additional steps (not shown) may also be added. One of ordinary skill in the art would recognize many variations, modifications, and alternatives. FIG. 4 shows exemplary process diagram 248 for thermally processing one or more substrates comprising providing a substrate 248-2, providing a heater or heater assembly 248-4 as described above and illustrated in FIG. 1, FIG. 1-1, FIG. 2, FIG. 2-1, FIG. 3, and FIG. 3-1. Specific examples of heaters suitable for exemplary process diagram 248 are electrical resistance heater 220, electrical resistance heater 220-1, electrical resistance heater 242, electrical resistance heater 242-1, and first heater 246-1. Exemplary process diagram 248 further comprises heating the substrate with the heater or heating assembly 248-6 to a process temperature and/or maintaining a process temperature.

As an option, exemplary process diagram 248 may also include one or more modifications for additional embodiments of the present invention. Exemplary modifications may include, but are not limited to, the following: Providing a process chamber capable of holding the one or more substrates so that the thermal process is performed in the process chamber. Providing a plurality of substrates for substantially simultaneous substrate processing. Rotating the substrate during heating the substrate 248-6. Providing a substrate 248-2 includes a substrate comprising a semiconductor wafer. Providing a substrate 248-2 includes a substrate for fabricating electronic and/or optoelectronic devices.

Embodiments of the present invention also include methods and apparatus for growing layers of materials such as elemental materials, compounds, compound semiconductors, and compound dielectric materials.

Presented next is an exemplary procedure that may be used to design a heater according to one embodiment of the present invention. The heater for this design is similar in configuration to the ring heater shown in FIG. 1. Input data used for the heater include the following: inside radius: 2.75 inches; outside radius: 4.85 inches; spacing between facing side surfaces: 0.060 inch; heater material: molded graphite having a resistivity of about 0.00049 ohm inch; heater angular size: substantially 360°; number of spokes: 101; angular width of spoke+spacing: 3.545 degrees; segment length: 0.21 inch; and initial trial thickness: 0.135 inch. The input data for this example is used with Equation (1) and Equation (2) to calculate the heating element cross-section width and the heating element cross-section thickness at radial positions incrementally increasing by an amount equal to the segment length so as to provide calculations ranging from the inside radius to the outside radius of the heater. The calculations are shown in Table 1. For this example are in, the calculations are performed at 11 equally spaced radial positions along one of the spokes including the inside radius and the outside radius.

Additional related calculations are also shown in Table 1 such as cross-section area of the heating element as a function of radial position and the resistance for each of the segmented lengths. The resistance for the segment lengths are totaled to give the total resistance for the spoke and multiplied by the number of spokes to determine the total resistance for the heating element. These calculations also aid in showing a possible approach a designer can use to modify the design of the heater so that it more closely matches a desired or optimum utilization of the power source capability. Specifically, a designer can select a different initial trial thickness and repeat the calculations to obtain the total resistance for the heating element for comparison with the desired or optimum resistance for use with a power supply. This iteration process can be continued until the total resistance for the heating element is an optimum or desired match of resistance for use with the power source.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” “includes,” “including,” “has,” “having,” “at least one of,” or any other variation thereof, are intended to cover a non-exclusive inclusion. For example, a process, method, article, or apparatus that comprises a list of elements is not necessarily limited only to those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

While there have been described and illustrated specific embodiments of the invention, it will be clear that variations in the details of the embodiments specifically illustrated and described may be made without departing from the true spirit and scope of the invention as defined in the appended claims and their legal equivalents.

TABLE 1
Input Data for Calculations

| Inside | Outside | Segment | Graphite | Initial Trial | Angular Width | Number of |
|---|---|---|---|---|---|---|
| Radius (in) | Radius (in) | Length (in) | Resistivity | Thickness (in) | (degrees) | Spokes |
| 2.75 | 4.85 | 0.21 | 0.00049 | 0.135 | 3.545 | 101 |

| | | | | Cross | Heater | Heater | |
|---|---|---|---|---|---|---|---|
| Radial | Circum- | Width of | Trial | Section | Element | Element | Resistance |
| Position | ference | Segment | Thickness | Area | Cross-Section | Cross-Section | of Segment |
| (in) | (in) | (in) | (in) | (sq. in) | Width (in) | Thickness (in) | (ohms) |
| 2.75 | 17.28 | 0.1701 | 0.135 | 0.02297 | 0.1101 | 0.2085 | 0.0045 |
| 2.96 | 18.60 | 0.1831 | 0.117 | 0.02134 | 0.1231 | 0.1733 | 0.0048 |
| 3.17 | 19.92 | 0.1961 | 0.102 | 0.01993 | 0.1361 | 0.1464 | 0.0052 |
| 3.38 | 21.24 | 0.2091 | 0.089 | 0.01869 | 0.1491 | 0.1253 | 0.0055 |
| 3.59 | 22.56 | 0.2221 | 0.079 | 0.01760 | 0.1621 | 0.1085 | 0.0058 |
| 3.80 | 23.88 | 0.2351 | 0.071 | 0.01662 | 0.1751 | 0.0949 | 0.0062 |
| 4.01 | 25.20 | 0.2481 | 0.063 | 0.01575 | 0.1881 | 0.0837 | 0.0065 |
| 4.22 | 26.52 | 0.2611 | 0.057 | 0.01497 | 0.2011 | 0.0744 | 0.0069 |
| 4.43 | 27.83 | 0.2741 | 0.052 | 0.01426 | 0.2141 | 0.0666 | 0.0072 |
| 4.64 | 29.15 | 0.2871 | 0.047 | 0.01361 | 0.2271 | 0.0599 | 0.0076 |
| 4.85 | 30.47 | 0.3001 | 0.043 | 0.01302 | 0.2401 | 0.0542 | 0.0079 |

| | |
|---|---|
| Spoke Resistance (ohms) | 0.0681 |
| Heater Resistance (ohms) | 6.8773 |

What is claimed is:

1. An electrical resistance heater comprising a sinusoidal heating element having a plurality of peaks disposed to delineate an outer radius and a plurality of troughs disposed to delineate an inner radius; the cross-section width of the heating element being a first function of radial position and the cross-section thickness of the heating element being a second function of radial position so that the heating element provides a substantially constant heat flux at each radial position and forms a substantially constant spacing between facing side surfaces of the heating element.

2. An electrical resistance heater according to claim 1, wherein the sinusoidal heating element is configured to heat a substantially flat surface.

3. An electrical resistance heater according to claim 1, wherein the cross-section thickness of the sinusoidal heating element is a function of the form f(1/r) where r is radial position on the heater.

4. An electrical resistance heater according to claim 1, wherein the cross-section width of the sinusoidal heating element is a function of the form f(r) where r is radial position on the heater.

5. An electrical resistance heater according to claim 1, wherein the cross-section area of the sinusoidal heating element is a function of the form (f1(1/r))(f2(r)).

6. An electrical resistance heater according to claim 1, wherein the cross-section thickness of the sinusoidal heating element is derived from the equation:
t=2πrᵢ²Gtᵢ/(2πr²G−Sr)
where
t is the cross-section thickness of the heating element,
r is the radial position on the heating element,
π is the mathematical constant pi,
rᵢ is the inside radius of the heating element,
tᵢ is the initial trial thickness,
G is a geometry factor equaling the angular width of the heating element spoke divided by the angular size of the heater, and
S is the spacing between facing side surfaces of the heating element.

7. An electrical resistance heater according to claim 1, wherein the cross-section width of the sinusoidal heating element is derived from the equation:
w=2πGr−S
where
w is the cross-section width of the heating element,
r is the radial position on the heating element,
π is the mathematical constant pi,
G is a geometry factor equaling the angular width of the heating element spoke divided by the angular size of the heater, and
S is the spacing between facing side surfaces of the heating element.

8. An electrical resistance heater according to claim 1, wherein the heating element comprises a refractory electrical conductor.

9. An electrical resistance heater according to claim 1, wherein the heating element comprises graphite.

10. An electrical resistance heater according to claim 1, wherein the heating element comprises graphite coated with silicon carbide.

11. An electrical resistance heater according to claim 1, wherein the heating element comprises a material selected from the group consisting of nickel-chromium alloy, molybdenum, tantalum, and tungsten.

12. An electrical resistance heater according to claim 1, wherein the spacing between facing side surfaces of the sinusoidal heating element is at vacuum or filled with gas.

13. An electrical resistance heater according to claim 1, further comprising electrical contacts and electrical adapters press-fit coupled thereto.

14. An electrical resistance heater according to claim 1, further comprising electrical contacts and electrical adapters press-fit coupled thereto and a thermally deposited coating applied to the heating element and the electrical adapters.

15. An electrical resistance heater according to claim 1, further comprising graphite electrical contacts and graphite electrical adapters press-fit coupled thereto and a thermally deposited silicon carbide overcoating applied to the heating element and the electrical adapters.

16. A system for processing a substrate, the system comprising a least one heater as recited in claim 1.

17. A heater assembly comprising at least one electrical resistance heater as recited in claim 1.

18. An electrical resistance heater comprising:
a graphite heating element having graphite electrical contacts;
graphite electrical adapters press-fit coupled to the graphite electrical contacts; and
a thermally deposited silicon carbide overcoating.

19. A method of thermally processing substrates, the method comprising:
providing one or more substrates;
providing an electrical resistance heater comprising a sinusoidal heating element having a plurality of peaks disposed to delineate an outer radius and a plurality of troughs disposed to delineate an inner radius; the cross-section width of the heating element being a first function of radial position and the cross-section thickness of the heating element being a second function of radial position so that the heating element provides a substantially constant heat flux at each radial position and forms a substantially constant spacing between facing side surfaces of the heating element; and
heating the one or more substrates using the heater.

20. The method of claim 19, further comprising rotating the one or more substrates during the heating.

21. The method of claim 19, wherein the one or more substrates comprise semiconductor wafers.

22. The method of claim 19, wherein the one or more substrates comprise substrates for fabricating electronic and/or optoelectronic devices.
